(19) United States
(12) Patent Application Publication
(10) Pub. No.: US 2025/0200186 A1
(43) Pub. Date: Jun. 19, 2025

(54) TARGETING OPERATING SYSTEM PROFILES FOR BARE METAL RESTORE

(71) Applicant: Microsoft Technology Licensing, LLC, Redmond, WA (US)

(72) Inventors: Krishna Kumar KB, Bengaluru (IN); Venkata Raghuram PAMPANA, Redmond, WA (US); Nivedita RAJANI, Bangalore (IN); Arulanandan PONNIVALAVAN, Bengaluru (IN); Siddhartha SAHANI, Bengaluru (IN); Dheeraj RAM, Bangalore (IN); Sashi Mouli NEMANI, Hyderabad (IN); Prabagar RAMADASSE, Sammamish, WA (US); Balasubramanian DELLI, Bangalore (IN); Robert Samual YORK, Redmond, WA (US)

(21) Appl. No.: 18/400,581

(22) Filed: Dec. 29, 2023

(30) Foreign Application Priority Data
Dec. 13, 2023 (IN) 202311085037

(51) Int. Cl. G06F 21/57

(52) U.S. Cl. CPC G06F 21/575; G06F 2221/034

(57) ABSTRACT

Example solutions enhance security of bootable media images during bare metal restores. A boot image generation request and original image integrity data is received from a first computing device. An original image timestamp associated with the boot image generation request is stored. A message is received from a second computing device that includes current image integrity data generated by the second computing device using a current boot image. The original image integrity data is verified to match the current image integrity data. The message is determined to have been received within a length of time from the original image timestamp. A registration of the second computing device is performed within the device management system based on the verification and the determination.

### BACKGROUND

Many businesses use a mobile device management (MDM) system or service to manage, secure, and enforce policies on computing resources used by the enterprise, such as employee computing devices, servers, laptops, smartphones, tablets, or the like (e.g., ‘endpoint devices’). Such MDM systems allow administrators to control how their organization's devices are used. These MDM systems may be provided as a cloud-based service or an on-premises management tool and can be used to deploy or upgrade software, applications, or apps, perform patch management, manage policies to enforce security compliance, perform hardware or software inventory tasks, or the like. Some MDM systems also provide functionality that helps end users recover (e.g., restore or rebuild) their personal devices in the event that their device becomes corrupted.

In offline bare-metal operating system recovery scenarios, an administrator of the MDM system configures a bootable media image profile that can identify, for example, an operating system version, language packs, software applications, or the like, through the MDM system. The end user can create a bootable media image on a different device (e.g., some other non-corrupted personal computing device) using the configured profile. This boot image may be saved to an external memory device such as a Universal Serial Bus (USB) disk (a ‘memory stick’) or the like. The user can then plug that USB disk into the corrupted computing device and perform an operating system installation from the USB disk to rebuild the corrupted device.

However, this process can be subject to malicious tampering, such as by the insertion of malicious content (e.g., malware) into the bootable media image or other modification of the operating system to expose a vulnerability. Such tampering with bootable media images can result in enterprise networks being infected with malware.

### SUMMARY

The disclosed examples are described in detail below with reference to the accompanying drawing figures listed below. The following summary is provided to illustrate some examples disclosed herein. The following is not meant, however, to limit all examples to any particular configuration or sequence of operations.

Example solutions for managing bare metal restores include: receiving, from a first computing device, a boot image generation request and original image integrity data generated by the first computing device using an original boot image; storing an original image timestamp associated with the boot image generation request; receiving, from a second computing device, a message that includes current image integrity data generated by the second computing device using a current boot image; verifying that the original image integrity data matches the current image integrity data; determining that the message was received within a length of time from the original image timestamp; and registering the second computing device with the device management system based on the verification and the determination.

### BRIEF DESCRIPTION OF THE DRAWINGS

The disclosed examples are described in detail below with reference to the accompanying drawing figures listed below:

FIG. 1 illustrates an example architecture of a mobile device management (MDM) system that advantageously provides security features to a bootable media image during a bare metal restore;

FIG. 2 is a sequence diagram illustrating example operations for generating a bootable media image;

FIG. 3 is a sequence diagram illustrating example operations for using the external disk to install an operating system onto the recovery device using a bootable media image;

FIG. 4 is a sequence diagram is a sequence diagram illustrating example operations for verifying the validity of a bootable media image;

FIG. 5 is a flowchart illustrating exemplary operations that may be performed by the MDM system for performing aspects of device management; and

FIG. 6 is a block diagram of an example computing device (e.g., a computer storage device) for implementing aspects disclosed herein, and is designated generally as a computing device.

Corresponding reference characters indicate corresponding parts throughout the drawings. Any of the drawings may be combined into a single example or embodiment.

### DETAILED DESCRIPTION

In examples, a mobile device management (MDM) system provides enhanced security functionality for bootable media images and their use during remote device installations, such as a bare-metal restore (e.g., a fresh operating system installation) of a corrupted computing device. An end user interacts with an MDM server to rebuild the corrupted device (a ‘recovery device’) using another computing device to which they have access (a ‘support device’), as well as an external memory device such as a USB disk.

During an image creation phase, the end user uses the support device to authenticate with the MDM server and download operating system (OS) data (e.g., an OS installation image or associated files, applications, and the like). To orchestrate aspects of the creation of this bootable media image and the rebuild process, the MDM server maintains a policy profile for the recovery device and other such devices managed by the MDM system. The policy profile allows administrators to configure settings for particular users, devices, or groups, identifying aspects such as OS version, pre-created OS image, applications, and the like. When an image creation is requested, the MDM server locates the policy for this particular recovery device or user and identifies OS data for that device. This OS data will be used to create a bootable media image on a portable memory device, such as a USB disk, which can then be plugged into the recovery device and used to rebuild that device.

Additionally, the MDM server also provides MDM enrollment metadata associated with the user or the recovery device that will later be used to authenticate and verify the (re) enrollment of the recovery device (e.g., during or after installation of the new OS). The support device creates the bootable media image to include the OS data and the MDM enrollment metadata and may also include an orchestrator program that can facilitate booting and installation of the OS data. Further, the support device also calculates image integrity data for portions of the bootable media image (e.g., a hash value, checksum, or digital signature of the OS data, the MDM enrollment metadata, the orchestrator program). This image integrity data is both stored in encrypted form on the USB disk and is transmitted to the MDM server for storage and later use. Further, when the image creation is completed by the support device, the MDM server also creates and stores an image validity timestamp. This timestamp marks the beginning of a window within which the image is valid (e.g., allowing the user to install the image within some preconfigured length of time from that timestamp).

After the bootable media image is completed on the USB disk, the user moves the USB disk from the support device to the recovery device to perform an OS install. During an OS installation phase, booting from the USB disk on the recovery device causes the orchestrator program to begin an OS installation procedure. The orchestrator program calculates current image integrity data for the bootable media image (e.g., as currently stored on the USB disk) and compares that current image integrity data to the image integrity data stored on the USB disk (e.g., as generated during the image creation phase and stored on the USB disk, and after decryption). If the image integrity data does not match, then the OS installation is terminated by the orchestrator program.

Further, the recovery device also sends the current image integrity data to the MDM server for a server-side verification. The MDM server compares the current image integrity data to the original image integrity data (e.g., as received from the support device during the image creation phase). If the image integrity data does not match, then the MDM server may deny enrollment into the MDM system for the recovery device or may take other actions in response. Additionally, the MDM server also uses the image timestamp (e.g., as created during the image creation phase) to determine whether or not the bootable media image is still valid (e.g., by comparing the image timestamp to the current time to determine whether or not the preconfigured time has already elapsed). If the bootable media image is no longer valid, the MDM server may similarly deny enrollment for the recovery device or take other actions in response.

As such, the MDM system provides both an integrity check during OS install (e.g., on the recovery device) as well as a server-side integrity verification (e.g., at the MDM server) to verify that no tampering with the bootable media image has occurred. The use of the timestamp serves as a staleness timer for use of the bootable media image, allowing administrators to control how long such images are valid. The example solutions provide technical advantages over existing approaches by, for example, receiving, from a first computing device, a boot image generation request and original image integrity data generated by the first computing device using an original boot image and storing an original image timestamp associated with the boot image generation request (e.g., during an image generation phase), and both verifying that the original image integrity data matches the current image integrity data as well as determining that the message was received within a length of time from the original image timestamp (e.g., during an OS installation phase). These operations allow the MDM system to verify the integrity of a bootable media image 110 during or prior to allowing the bootable media image's use in an operating system installation, thus enhancing security.

The various examples are described in detail with reference to the accompanying drawings. Wherever preferable, the same reference numbers is used throughout the drawings to refer to the same or like parts. References made throughout this disclosure relating to specific examples and implementations are provided solely for illustrative purposes but, unless indicated to the contrary, are not meant to limit all examples.

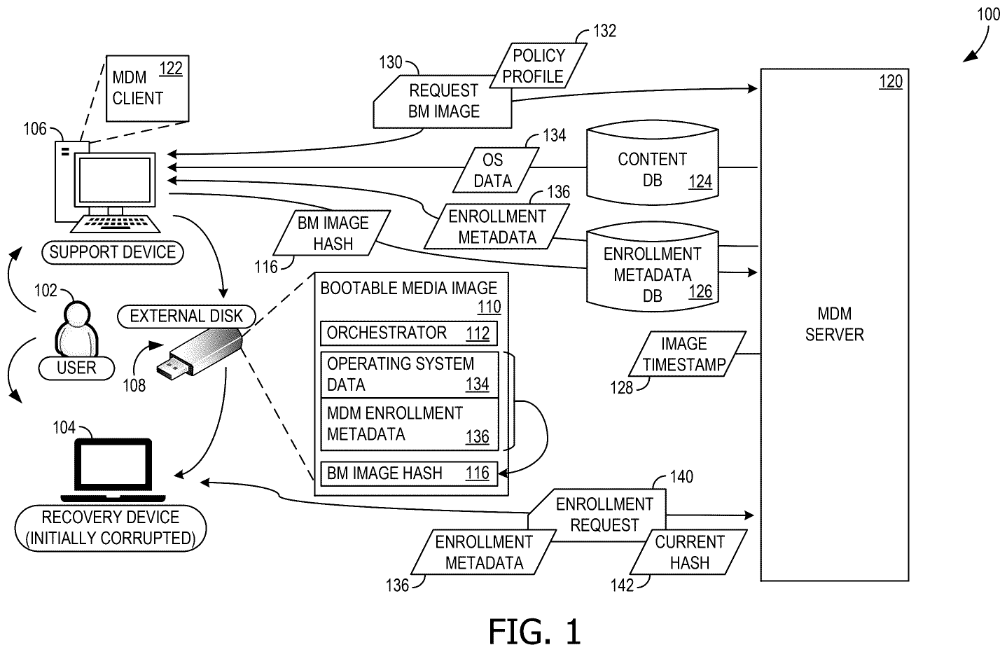

FIG. 1 illustrates an example architecture of a mobile device management (MDM) system 100 that advantageously provides security features to bootable media images during bare metal restores. In examples, a computing device of a user 102 (shown here as recovery device 104) has somehow been corrupted during day-to-day operation and the user 102 wishes to reinstall a new OS onto the device 104. For purposes of these examples, the recovery device 104 is presumed to be a PC or laptop computing device that the user 102 uses to perform their job functions for an enterprise business. Further, and prior to the corrupting event, the recovery device 104 is presumed to have been registered in the MDM system 100 (e.g., as an ‘endpoint device’), thus allowing an MDM server 120 to perform certain security and management functions to manage the device 104 and other such computing devices in an enterprise network, such as device provisioning and configuration, security and compliance, software deployment, inventory management, health monitoring and patching, backup and recovery, remote troubleshooting, and the like.

In these examples, and in addition to any or all of the other functionalities described above, the MDM system 100 provides a device recovery feature that helps the user 102 rebuild the recovery device 104. More specifically, this device recovery feature allows the user 102 to use another computing device (in this example, the support device 106) to create a bootable media image 110 on a memory device (e.g., eternal disk 108) that can then be moved to the recovery device 104 and used to (re) install an OS and re-register with the MDM system 100. For purposes of these examples, the support device 106 is presumed to be another PC or laptop computing device to which the user 102 has physical access (e.g., for connecting and disconnecting the external disk 108) and logical access (e.g., for performing certain software operations on the device 106). Further, in these examples, the external disk 108 is a USB memory device (e.g., a memory stick) of sufficient size to store the bootable media image 110. However, it should be understood that other bootable memory devices can be used to facilitate these recovery operations as described herein, such as CD-ROM or DVD disk devices, hot-swapable hard disk devices, or the like.

In this example, the user 102 mounts the external disk 108 to the support device 106. Further, an MDM client application (or just ‘MDM client’) 122 is installed onto the support device 106. This MDM client 122 may be installed as part of a registration process performed by the user 102 between the support device 106 and the MDM server 120 (e.g., after the user 102 authenticates with the MDM server 120). In other examples, the MDM client 122 may be functionality provided to the support device 106 via a web browser in conjunction with the MDM server 120. In these examples, it is presumed that the MDM client 122 can be used to perform any or all of the operations that are described as occurring on support device 106.

During an image creation phase, the support device 106 requests 130 creation of a bootable media image. This request 130 can include identifying information for the user 102 or the recovery device 104 which may be used by the MDM server 120 to identify a policy profile 132 for that user 102 or device 104. This policy profile 132 is configured by an administrator of the MDM system 100 to include settings and the like for the user 102 or device 104, such as an OS type, version, architecture, patch level, OS settings, security settings, a policy group, or the like. During this request 130, the MDM server 120 authenticates the user 102 and verifies that the user 102 is allowed to generate a bootable media image for their device 104. Once the request 130 is verified, the MDM server 120 identifies the OS data 134 to be used by the support device 106 to build this bootable media image 110 (e.g., a particular OS build image, installation files, or the like, for a particular OS version/architecture as identified by the policy profile 132 for this user 102 or device 104). In some examples, the MDM server 120 sends location information for the OS data 134 to the support device 106 and the support device 106 requests the OS data 134 from a content DB 124.

Additionally, the request 130 also causes the MDM server 120 to send MDM enrollment metadata (or just ‘enrollment metadata’) 136 to the support device 106 from an enrollment metadata DB 126 for inclusion in the bootable media image 110. This enrollment metadata 136 can include, for example, user data (e.g., user ID, user name), device data (e.g., device ID, serial number, hardware ID(s), IP address, hardware hash, UPN), and/or tenant data (e.g., tenant ID, company name) of the user 102 and/or device 104. This enrollment metadata 136 is data that is configured by administrators of the MDM system 100, may be configured specifically for a bare metal restore (though may be used for other purposes such as reporting), and may be encrypted by the MDM server 120 before transmission to the support device 106.

The support device 106 creates the bootable media image 110 by writing the OS data 134 and the MDM enrollment metadata 136 to the external disk 108. In some examples, the OS data 134 may be a bootable image (e.g., may include a bootloader that is written to a boot sector on the external disk 108 and that is configured to start a boot process allowing an installation of a new operating system using the OS data 134). In the example, the support device 106 writes an orchestrator program 112 to the external disk 108 and the bootloader is included with the orchestrator program 112. This orchestrator program 112 can be configured to perform additional operations during a boot from the external disk 108 as described below (e.g., local image integrity validation).

The support device 106 also generates image integrity data for the bootable media image 110 and stores that data on the external disk 108. This image integrity data, in the example, is a bootable media image hash 116, a hash value generated via a hash function (e.g., Message Digest Algorithm 5 (MD5), Secure Hash Algorithm 256-bit (SHA-256), or the like). This BM image hash 116 is used for integrity validation of the bootable media image 110 and is generated using at least the OS data 134 as initially received by the support device 106 (e.g., from the content DB 124) and as initially written to the external disk 108 (e.g., as the ‘message’ input to the hash function). In the example, the BM image hash 116 is created using both the OS data 134 and the MDM enrollment metadata 136 (e.g., concatenated together as the input message). In other examples, the input message may also include the orchestrator 112. In some examples, the support device 106 may generate a separate hash value for any or all of the OS data 134, the MDM enrollment metadata 136, and the orchestrator 112 and may store any or all of those hash values on the external disk 108.

In the example, the BM image hash 116 is sent to and stored by the MDM server 120 for later use (e.g., server-side integrity validation). Further, in the example, the BM image hash 116 is encrypted by the support device 106 prior to the writing of the BM image hash 116 to the external disk 108 and may be sent to the MDM server 120 in encrypted form. In some examples, the BM image hash 116 is encrypted on the external disk 108 using password-based encryption (PBE) in which the user 102 is prompted for a password as input prior to the encryption and storage of the BM image hash 116 onto the disk 108. In some examples, the BM image hash 116 sent to the MDM server 120 is encrypted by the support device 106 using public key encryption (e.g., using a public key of the MDM server 120).

In the example, the MDM server 120 generates an image timestamp 128 for this particular image generation process. This image timestamp 128 is used to identify the beginning of a time period within which this bootable media image 110 is considered valid by the MDM server 120 and system 100. The MDM server 120 may generate the image timestamp 128 when the request 130 for creation of the BM image 110 is first received, when the OS data 134 is sent to the support device 106, or when the BM image hash 116 is received from the support device 106. This image timestamp 128 is stored by the MDM server 120 for later use.

After the bootable media image 110 is completely written to the external disk 108, the user 102 moves the external disk 108 from the support device 106 to the recovery device 104 to begin an OS installation phase. To start the OS installation phase, the user 102 boots the recovery device 104 from the external disk 108. In the example, the orchestrator 112 includes the bootloader that begins a boot process from the bootable media image 110. The orchestrator 112 is configured to perform a local image integrity validation of the OS data 134 and/or the MDM enrollment metadata 136 using the BM image hash 116.

More specifically, the orchestrator 112 generates a ‘current BM image hash’ (e.g., using the same hashing function used by the support device 106 to generate the BM image hash 116) and using the OS data 134 and MDM enrollment metadata 136 (and possibly also the orchestrator 112) currently stored on the external disk 108. In encrypted examples, the orchestrator 112 also decrypts the BM image hash 116 from the external disk 108 (e.g., prompting the user 102 for the password they used during encryption). The orchestrator 112 compares the current image hash to the BM image hash 116 from the external disk 108 to verify that they are identical. In some examples, if the hash values do not match, the orchestrator 112 terminates the OS installation phase and displays an error to the user 102.

After local image integrity validation is successfully complete, the orchestrator 112 performs an installation of a new operating system on the recovery device 104 using the OS data 134 from the bootable media image 110. This OS installation process is presumed to include writing OS data 134 from the external disk 108 to the recovery device 104 (e.g., to internal storage, not separately shown).

During the OS installation phase, an enrollment request 140 is sent from the recovery device 104 to the MDM server 120. In the example, the enrollment request 140 includes the enrollment metadata 136 and the current image hash generated by the orchestrator 112 (shown here as current hash 142). Either or both of the enrollment metadata 136 and the current hash 142 may be encrypted by the recovery device 104 prior to transmission (e.g., using the public key of the MDM server 120 as stored by the orchestrator 112 or as provided by the MDM server 120 during this enrollment process).

The MDM server 120 performs a server-side image integrity check of the BM image 110, as well as a temporal validity check of this OS installation process on this recovery device 104. More specifically, in the example server-side image integrity check, the MDM server 120 compares the current hash 142 to the BM image hash 116 as originally received from the support device 106 (e.g., during the image generation phase) to verify that there was no tampering with the bootable media image 110 during this process. If the hash values do not match, the MDM server 120 may deny enrollment of the recovery device 104 into the MDM system 100 or take other corrective actions (e.g., alerting the user 102 or administrators, flagging the recovery device 104 as potentially corrupt or infected, or the like). Further, the MDM server 120 also verifies the integrity of this process by comparing the enrollment metadata 136 received from the recovery device 104 to the enrollment metadata 136 as initially provided to the support device 106. Likewise, if this metadata comparison is not successful, the enrollment of the recovery device 104 may be denied or other corrective actions may be taken.

Further, as a temporal validity check of the bootable media image 110, the MDM server 120 also determines whether the bootable media image 110 has expired. In the example, at the time the enrollment request 140 is received from the recovery device 104, the MDM server 120 determines an elapsed time between the image timestamp 128 (e.g., the original timestamp created during the image generation phase) and the current time. This elapsed time is compared to an image validity duration for the bootable media image 110 to determine whether or not the bootable media image 110 is unexpired. For example, an administrator may configure an image validity duration of two hours (e.g., as a pre-configured setting for the user 102, the recovery device 104, for a group of devices to which the recovery device 104 belongs, as part of the policy profile 132 associated with this device 104, or the like). As such, the bootable media image 110 is considered valid if less than two hours has elapsed between the time the bootable media image 110 was generated (e.g., as identified by the image timestamp 128) and the time the bootable media image 110 is being installed on the recovery device 104 (e.g., as identified by the time the enrollment request 140 is received). Similarly, if the BM image 110 is determined to be stale, the MDM server 120 may deny enrollment for the recovery device 104 or take other corrective actions.

In some examples, the orchestrator 112 may send the enrollment request 140 prior to starting the OS installation process onto the internal storage of the recovery device 104, and may terminate the OS installation if the enrollment request 140 is denied, thus allowing the MDM server 120 to effectively prohibit the BM image 110 from being used to perform the OS installation on the recovery device 104.

As such, the MDM system 100 has performed an image integrity check of the BM image 110 both locally on the recovery device 104 (e.g., at boot time during the OS installation phase) and remotely on the MDM server 120 (e.g., upon receipt of the enrollment request 140). Further, the MDM system 100 has provided a temporal check of the BM image 110, thus allowing the MDM system 100 to expire BM images 110 after some configurable period of time. These features provide enhanced security to the recovery process, allowing a customized BM image 110 to be created and checked before the recovery device 104 is reintroduced into the MDM system 100.

While the example support device 106 and recovery device 104 are depicted in FIG. 1 as a personal computer and a laptop, respectively, it should be understood that either the support device 106 or the recovery device 104 can be any type of computing device that enables the systems and methods described herein. Further, while the external disk 108 is depicted in FIG. 1 as a USB memory stick, it should be understood that the external disk 108 can be any type of bootable external memory device that enables the systems and methods described herein. Further, while the MDM system 100 shown in FIG. 1 is depicted as a client/server architecture, it should be understood that the MDM system 100 may be provided in a cloud architecture, as a software service, or the like. Additionally, while these examples depict the recovery device 104 as having been corrupted by some event, it should be understood that these systems and methods can be used in other scenarios, such as for performing a fresh OS install on the device 104 (e.g., regardless of corruption).

In some examples, the bootable media image 110 may be stored remotely from the support device 106 and the recovery device 104 (e.g., in lieu of the external disk 108). In such examples, the BM image 110 may be created and stored by the MDM server 120 and may be provided to the recovery device 104 at boot time (e.g., via preboot execution environment (PXE), or the like). As such, the MDM server 120 may perform the steps of the image generation phase, perhaps in conjunction with the user 102 working via the support device 106, but with the BM image 110 being stored and made remotely available by the MDM server 120. During the OS installation phase, the recovery device 104 may thus perform a network boot from the MDM server 120 and the BM image 110. In some examples, this OS installation phase may eliminate the image integrity checks of the hash 116 and enrollment metadata 136 (e.g., as the MDM server 120 retained control of the BM image 110), but may still perform the temporal validity check (e.g., to expire the BM image 110 after the preconfigured time).

In some examples, the MDM server 120 may track how long recovery operations take for many requests 130 (e.g., the length of time between a particular image timestamp 128 and a subsequent enrollment request 140 associated with a given request 130). This recovery time (e.g., as an aggregate average, mean, range, or the like) to determine an expiration time to use for future requests 130. In some examples, the MDM server 120 may automatically adjust the expiration time to use for requests 130 based on the average recovery time (e.g., expiration time=average recovery time plus one hour). In some examples, the MDM server 120 may train a machine learning model on historical requests 130. This model may be configured to, for example, dynamically identify an expiration time for a given request 130 (e.g., based on the OS type, what devices are corrupted more often, what recoveries take more OS installation time, and the like).

In some examples, the MDM server 120 may create one or more OS images on a regular basis (e.g., for various versions of operating systems commonly used and supported within the system 100) and may store these images in the content DB 124 for use as OS data 134 in future requests 130.

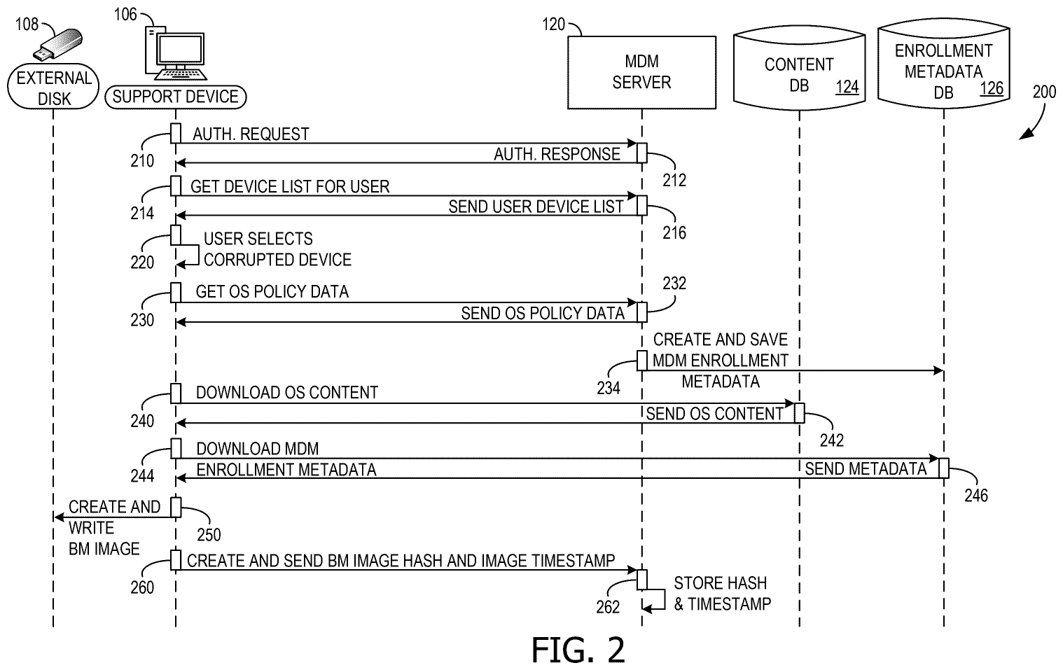

FIG. 2 is a sequence diagram 200 illustrating example operations for generating a bootable media image. In the example, these operations are performed by the MDM system 100 shown in FIG. 1 using the support device 106, the MDM server 120, and other components, as shown here. At operation 210, the user 102 initiates the request 130 to generate a new bootable media image 110 via an authentication request with the MDM server 120. This authentication request can include, for example, the user 102 performing a user ID and password authentication with the MDM server 120, resulting in a successful authentication of the user 102 at operation 212.

At operation 214, the support device 106 requests a device list from the MDM server 120. This device list represents a set of one or more devices that are configured within the MDM system 100 and that are somehow associated with the user 102. In the example, the recovery device 104 is presumed to be the primary work device of the user 102 and, as such, the recovery device 104 is included in the device list sent from the MDM server 120 to the support device 106 at operation 216. At operation 220, the support device 106 displays the device list to the user 102 and the user 102 selects the recovery device 104 (e.g., as the target device for which the BM image 110 will eventually be used).

At operation 230, the support device 106 requests OS policy data from the MDM server 120. This OS policy data may be similar to the policy profile 132 shown in FIG. 1. The OS policy data identifies what particular OS data 134 is to be used to create the BM image 110 for this particular user 102 and recovery device 104 and may include source information for that OS data 134 (e.g., uniform resource locator (URL), image ID, or the like, to access the OS data via the content DB 124). For example, the MDM server 120 may look up the configuration of the recovery device 104 within the MDM system 100 to determine that the recovery device 104 is configured to run Windows 11 (64-bit) and, as such, the MDM server 120 sends a link to a Windows 11 64-bit OS image (e.g., as provided by the content DB 124) to the support device at operation 232. Further, the MDM server 120 also creates and saves MDM enrollment metadata 136 to the enrollment metadata DB 126 at operation 234.

At operation 240, the support device 106 requests the OS data 134 from the content DB 124 (e.g., identifying the OS data 134 identified by the MDM server 120 in the OS policy data), and the content DB 124 sends the OS data 134 to the support device 106 in response at operation 242. At operation 244, the support device 106 requests the MDM enrollment metadata 136 from the enrollment metadata DB 126, which is sent in response at operation 246.

At operation 250, the support device 106 creates the BM image 110 by writing the various components to the external disk 108. More specifically, in the example, the support device 106 writes the orchestrator program 112 to the external disk 108 (e.g., including a bootloader to the boot sector). The support device 106 also writes the OS data 134 and the MDM enrollment metadata 136 to the external disk 108. Further, the support device 106 also computes the BM image hash 116 for the BM image 110 and writes that BM image hash 116 to the external disk 108, perhaps in encrypted form. Further, at operation 260, the support device 106 sends the BM image hash 116 to the MDM server 120. In some examples, the support device 106 also creates and sends the image timestamp 128 to the MDM server 120, where in other embodiments, the image timestamp 128 is created by the MDM server 120 (e.g., upon receipt of the BM image hash 116). At operation 262, the MDM server 120 stores the BM image hash 116 and the image timestamp 128 for later use.

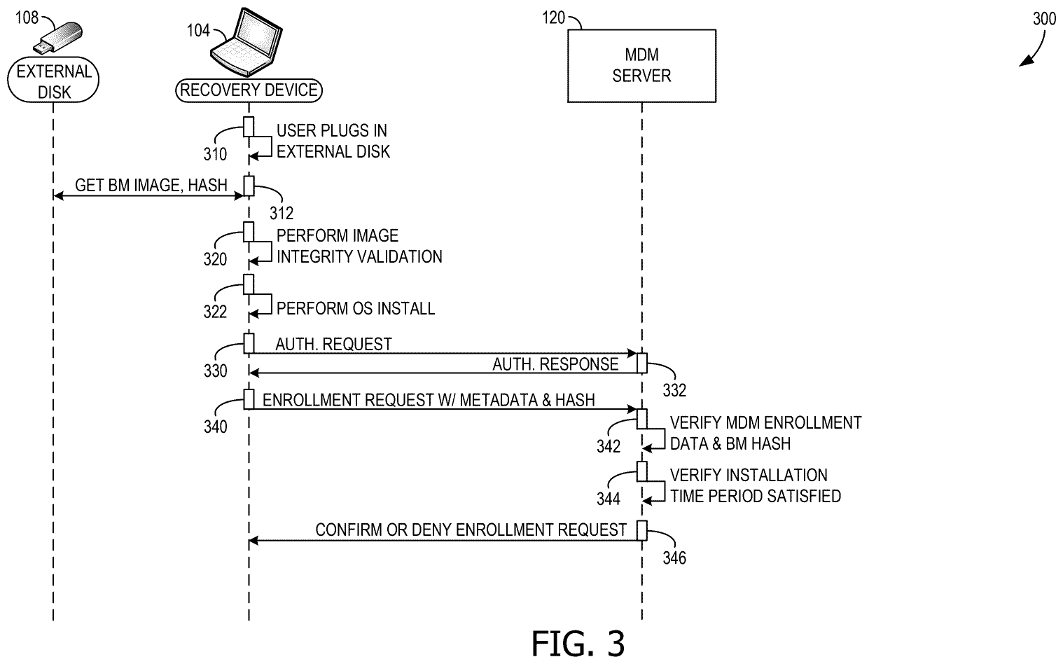

FIG. 3 is a sequence diagram 300 illustrating example operations for using the external disk 108 to install an operating system onto the recovery device 104 using the bootable media image 110. In the example, these operations are performed by the MDM system 100 shown in FIG. 1 using the recovery device 104, the MDM server 120, and the external disk 108. At operation 310, the user 102 plugs the external disk 108 into the recovery device 104 and boots the recovery device 104 from the external disk 108 (e.g., via a BIOS boot option on the recovery device 104, or the like). This boot process includes reading and executing the bootloader from the boot sector of the disk 108, which invokes execution of the orchestrator 112 of the BM image 110 in this example.

At operation 312, the recovery device 104 (e.g., the orchestrator 112) reads components of the BM image 110 from the external disk 108. In the example, this operation 312 includes reading the OS data 134, the MDM enrollment metadata 136, and the BM image hash 116. At operation 320, the recovery device 104 performs an image integrity validation of the BM image 110. More specifically, in the example, the recovery device 104 generates a current hash value using the OS data 134 and the MDM enrollment metadata 136, as read from the external disk 108. This current hash value is then compared to the BM image hash 116, as read from the external disk 108 (perhaps decrypted using a password provided by the user 102 after prompting). If the current hash value does not match the (decrypted) BM image hash 116, then this OS installation process may be terminated. Otherwise, at operation 322, the recovery device 104 performs an OS install using the OS data 134. This OS install can include, for example, copying an OS image from the OS data 134 to local storage of the recovery device 104, or executing an OS installation process from the OS data 134 that subsequently causes an OS installation to occur on the local storage.

At operation 330, the recovery device 104 sends an authentication request to the MDM server 120 (e.g., including a user ID and password provided by the user 102) and, in response, the user 102 is authenticated at operation 332. At operation 340, the recovery device 104 sends an enrollment request 140 to the MDM server 120. The enrollment request 140 includes the MDM enrollment metadata 136 as read from the external disk 108 (which may similarly be decrypted, and which may be encrypted before sending to the MDM server 120) as well as the current hash 142 as computed at operation 320 (which should be identical to the unencrypted BM image hash 116 at this stage).

At operation 342, the MDM server 120 performs a server-side integrity check of the BM image 110 by verifying the MDM enrollment metadata 136 and the current hash 142 of the BM image 110. This operation 342 includes comparing the MDM enrollment metadata 136 to the source enrollment metadata to ensure that they match, as well as comparing the current hash 142 to the BM image hash 116 as originally received from the support device 106 during the image generation phase. Further, at operation 344, the MDM server 120 performs a temporal validity check of this use of the BM image 110 by verifying that an installation time period is satisfied (e.g., that the OS install is conducted within a predetermined period of time from the image timestamp 128 as created during the image generation phase). At operation 346, the MDM server 120 either confirms or denies the enrollment request 140. In some examples, if either of the image integrity checks fail, or if the temporal validity check fails, then the enrollment request 140 may be rejected, or may be approved but other corrective actions may be taken for the recovery device 104 in light of the failure(s).

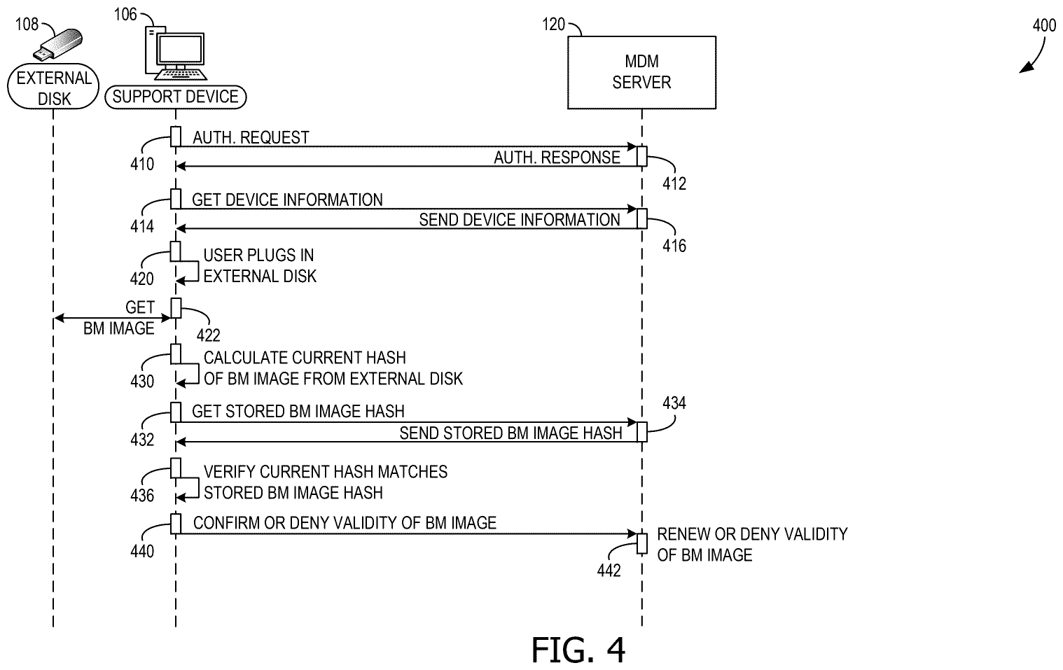

FIG. 4 is a sequence diagram 400 is a sequence diagram 400 illustrating example operations for verifying the validity of the bootable media image 110. In the example, these operations are performed by the MDM system 100 shown in FIG. 1 using the support device 106, the MDM server 120, and other components, as shown here. In some situations, the BM image 110 may have expired or otherwise may be dated such that a reverification of the BM image 110 is desired before further use (e.g., in lieu of recreating the BM image 110 from scratch).

As such, at operation 410, the support device 106 sends an authentication request to the MDM server 120 (e.g., to authenticate the user 102), resulting in an authentication response at operation 412. At operation 414, the support device 106 requests device information from the MDM server 120 and receives device information in response at operation 416. These operations 414, 416 may be similar to operations 214 and 216 shown in FIG. 2, and may include the user 102 selecting the particular device 104 like operation 220 of FIG. 2. At operation 420, the user 102 plugs the external disk 108 into the support device 106. At this stage, it is presumed that the BM image 110 is already written on the external disk 108, and it is this BM image 110 that is the subject of this validity verification process of FIG. 4.

At operation 422, the support device reads data from the BM image 110. This operation 422 can include reading any or all components of the BM image 110, such as the orchestrator 112, the OS data 134, the MDM enrollment metadata 136, and the BM image hash 116. At operation 430, the support device 106 calculates a current hash for components of the BM image 110. In the example, the current hash is calculated using the OS data 134 and the MDM enrollment metadata 136. At operation 432, the support device 106 requests a stored BM image hash from the MDM server 120. The MDM server 120 sends back the BM image hash 116 originally received during the image generation phase for this BM image 110 at operation 434. At operation 436, the support device 106 compares the current image hash to the stored BM image hash 116 to verify that the hashes match. At operation 440, the support device 106 sends a message to the MDM server 120 either confirming or denying the validity of the BM image 110. At operation 442, if the validity of the BM image 110 is confirmed, the MDM server 120 renews the validity of the BM image 110 (e.g., by updating the image timestamp 128 to a current time, thus making the image 110 active and valid for another preconfigured length of time).

In the example, operations 432 to 436 perform a local integrity check (e.g., on the support device 106) using the BM image hash 116 as stored and provided by the MDM server 120. In other examples, the MDM server 120 may perform a server-side integrity check. For example, operation 432 may instead include sending the current image hash from the support device 106 to the MDM server 120 and the MDM server 120 may perform the comparison of the current image hash with the original BM image hash 116 to confirm or deny the validity of the BM image 110.

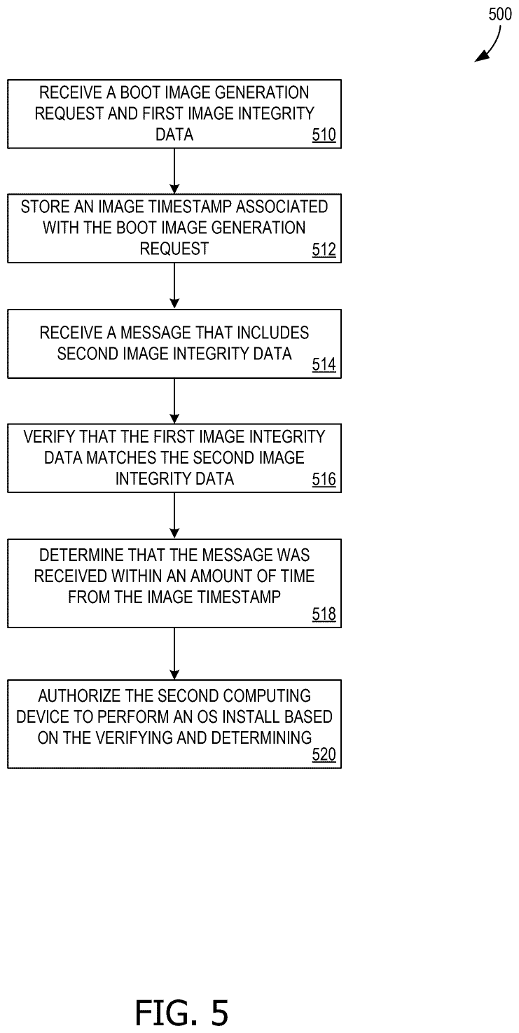

FIG. 5 is a flowchart 500 illustrating exemplary operations that may be performed by the MDM system 100 for performing aspects of device management. In some examples, the operations of flowchart 500 may be similar to the operations described in FIG. 1 through FIG. 4. In some examples, any or all of the operations described in FIG. 1 through FIG. 4 may be performed by the MDM server 120, the support device 106, or the recovery device 104 as a part of these exemplary operations and as described in FIG. 1 through FIG. 4. In the example implementation, the operations of flowchart 500 are presumed to be performed by the MDM server 120 of FIG. 1 unless otherwise indicated.

At operation 510, the MDM server 120 receives, from a first computing device (e.g., the support device 106 of FIG. 1), a boot image generation request (e.g., the request 130) and original image integrity data generated by the first computing device (e.g., the BM image hash 116) using an original boot image (e.g., the bootable media image 110 as initially written to the external disk 108 by the support device 106). In some examples, the original image integrity data includes an original hash value generated by a hash algorithm using at least operating system data included in the original boot image (e.g., OS data 134), wherein the current image integrity data includes a current hash value generated by the hash algorithm using at least operating system data included in the current boot image (e.g., as read from the BM image 110 by the recovery device 104).

At operation 512, the MDM server 120 stores an original image timestamp (e.g., the image timestamp 128 of FIG. 1) associated with the boot image generation request. In some examples, storing the original image timestamp further comprises generating the original image timestamp in response to receipt of the original image integrity data from the first computing device.

At operation 514, the MDM server 120 receives, from a second computing device (e.g., the recovery device 104 of FIG. 1), a message (e.g., the enrollment request 140) that includes current image integrity data (e.g., current hash 142 of FIG. 1) generated by the second computing device using a current boot image (e.g., the bootable media image 110 as read from the external disk 108 by the recovery device 104). At operation 516, the MDM server 120 verifies that the original image integrity data (e.g., the BM image hash 116 received from the support device 106) matches the current image integrity data (e.g., the current hash 142).

At operation 518, the MDM server 120 determines that the message was received within a length of time (e.g., an image validity duration) from the original image timestamp (e.g., the image timestamp 128). In some examples, the length of time is a preconfigured length of time identified based on one or more of an identity of an end user (e.g., user 102) associated with the second computing device (e.g., the recovery device 104) and a unique identifier associated with the second computing device (e.g., a hardware ID or the like).

At operation 520, the MDM server 120 authorizes the second computing device to perform an operating system installation (e.g., onto internal storage of the recovery device 104) using the current boot image based on the verifying and the determining. In some examples, operation 520 additionally or alternatively includes registering the second computing device with a device management system (e.g., MDM system 100) based on the verification (e.g., operation 516) and the determination (e.g., operation 518).

In some examples, the MDM server 120 also transmits original enrollment metadata (e.g., MDM enrollment metadata 136 of FIG. 1) to the first computing device in response to the boot image generation request, the original enrollment metadata including one or more of user data, device data, and tenant data, the original enrollment metadata being included in the original boot image, receiving current enrollment metadata (e.g., the enrollment data 136 of the enrollment request 140 of FIG. 1) from the second computing device, and verifying that the current enrollment metadata matches the original enrollment data.

In some examples, the MDM server 120 also identifies a policy profile (e.g., policy profile 132 of FIG. 1) for the boot image generation request based on device data provided in the boot image generation request that identifies the second computing device, the policy profile defines at least an operating system version, identifies operating system data associated with the operating system version (e.g., OS data 134), and transmits the operating system data to the first computing device, the operating system data being included as at least a portion of the original boot image (e.g., as OS data 134 on the BM image 110).

In some examples, the recovery device 104 is configured to perform a local integrity check of the current boot image during a boot process of the second computing device and from an external disk device that is mounted to the second computing device and that stores at least the current boot image (e.g., the bootable media image 110 as stored on and read from the external disk 108). This local integrity check includes reading the original image integrity data (e.g., the BM image hash 116) from the external disk device, computing the current image integrity data (e.g., the current hash 142) using at least operating system data retrieved from the external disk device (e.g., the OS data 134), comparing the original image integrity data to the current image integrity data, and performing an operating system installation on the second computing device when the original image integrity data matches the current image integrity data.

### ADDITIONAL EXAMPLES

In some examples, the bootable media image generation and bare metal restore processing techniques described herein employ features that enhance security of bootable media images and their use better than some other known methods, and thus provide an improvement in a technical field by using such an approach.

An example device management system comprises: a processor; and a computer-readable medium storing instructions that are operative upon execution by the processor to: receive, from a first computing device, a boot image generation request and original image integrity data generated by the first computing device using an original boot image; store an original image timestamp associated with the boot image generation request; receive, from a second computing device, a message that includes current image integrity data generated by the second computing device using a current boot image; verify that the original image integrity data matches the current image integrity data; determine that the message was received within a length of time from the original image timestamp; and register the second computing device with the device management system based on the verification and the determination.

An example computer-implemented method comprises: receiving, from a first computing device, a boot image generation request and original image integrity data generated by the first computing device using an original boot image; storing an original image timestamp associated with the boot image generation request; receiving, from a second computing device, a message that includes current image integrity data generated by the second computing device using a current boot image; verifying that the original image integrity data matches the current image integrity data; determining that the message was received within a length of time from the original image timestamp; and registering the second computing device with the device management system based on the verification and the determination.

An example computer storage device having computer-executable instructions stored thereon is provided. On execution by a computer, the instructions cause the computer to perform operations comprising: receiving, from a first computing device, a boot image generation request and original image integrity data generated by the first computing device using an original boot image; storing an original image timestamp associated with the boot image generation request; receiving, from a second computing device, a message that includes current image integrity data generated by the second computing device using a current boot image; verifying that the original image integrity data matches the current image integrity data; determining that the message was received within a length of time from the original image timestamp; and registering the second computing device with the device management system based on the verification and the determination.

Alternatively, or in addition to the other examples described herein, examples include any combination of the following:
receiving a boot image generation request;
receiving original image integrity data generated by the first computing device using an original boot image;
storing an original image timestamp associated with the boot image generation request;
generating an original image timestamp by recording a time value;
receiving a message that includes current image integrity data;
current image integrity data is generated by a computing device using a current boot image read from an external disk device;
verifying that original image integrity data matches the current image integrity data;
determining that a message was received within a length of time from the original image timestamp;
authorizing a computing device to perform an operating system installation using the current boot image based on the verifying and the determining;
registering a computing device with a device management system based on the verification and the determination;
transmitting original enrollment metadata in response to receipt of a boot image generation request;
original enrollment metadata that includes one or more of user data, device data, and tenant data;
storing original enrollment metadata being in an original boot image;
receiving current enrollment metadata from the second computing device;
verifying that the current enrollment metadata matches the original enrollment data;
original image integrity data includes an original hash value generated by a hash algorithm using at least operating system data included in an original boot image;
current image integrity data includes a current hash value generated by the hash algorithm using at least operating system data included in a current boot image;
identifying a policy profile for the boot image generation request based on device data provided in the boot image generation request that identifies the second computing device;
a policy profile that defines at least an operating system version;
identifying operating system data associated with the operating system version;
transmitting the operating system data to the first computing device, the operating system data being included as at least a portion of the original boot image;
storing the original image timestamp includes generating the original image timestamp in response to receipt of the original image integrity data from the first computing device;
a preconfigured length of time identified based on one or more of an identity of an end user associated with the second computing device and a unique identifier associated with the second computing device;
performing a local integrity check of the current boot image during a boot process of the second computing device and from an external disk device that is mounted to the second computing device and that stores at least the current boot image;
reading the original image integrity data from the external disk device;
computing the current image integrity data using at least operating system data retrieved from the external disk device;
comparing the original image integrity data to the current image integrity data; and
performing an operating system installation on the second computing device when the original image integrity data matches the current image integrity data.

While the aspects of the disclosure have been described in terms of various examples with their associated operations, a person skilled in the art would appreciate that a combination of operations from any number of different examples is also within scope of the aspects of the disclosure.

### Example Operating Environment

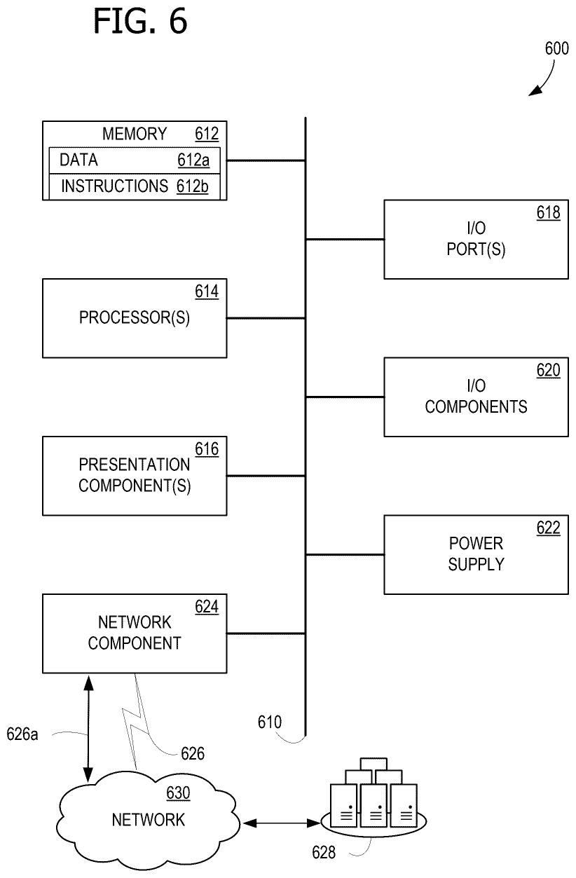

FIG. 6 is a block diagram of an example computing device 600 (e.g., a computer storage device) for implementing aspects disclosed herein, and is designated generally as computing device 600. In some examples, one or more computing devices 600 are provided for an on-premises computing solution. In some examples, one or more computing devices 600 are provided as a cloud computing solution. In some examples, a combination of on-premises and cloud computing solutions are used. Computing device 600 is but one example of a suitable computing environment that can be used in the MDM system 100 (e.g., as recovery device 104, support device 106, MDM server 120) and is not intended to suggest any limitation as to the scope of use or functionality of the examples disclosed herein, whether used singly or as part of a larger set. Neither should computing device 600 be interpreted as having any dependency or requirement relating to any one or combination of components/modules illustrated.

The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 600 includes a bus 610 that directly or indirectly couples the following devices: computer storage memory 612, one or more processors 614, one or more presentation components 616, input/output (I/O) ports 618, I/O components 620, a power supply 622, and a network component 624. While computing device 600 is depicted as a seemingly single device, multiple computing devices 600 may work together and share the depicted device resources. For example, memory 612 may be distributed across multiple devices, and processor(s) 614 may be housed with different devices.

Bus 610 represents what may be one or more busses (such as an address bus, data bus, or a combination thereof). Although the various blocks of FIG. 6 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 6 and the references herein to a “computing device.” Memory 612 may take the form of the computer storage media referenced below and operatively provide storage of computer-readable instructions, data structures, program modules and other data for the computing device 600. In some examples, memory 612 stores one or more of an operating system, a universal application platform, or other program modules and program data. Memory 612 is thus able to store and access data 612a and instructions 612b that are executable by processor 614 and configured to carry out the various operations disclosed herein.

In some examples, memory 612 includes computer storage media. Memory 612 may include any quantity of memory associated with or accessible by the computing device 600. Memory 612 may be internal to the computing device 600 (as shown in FIG. 6), external to the computing device 600 (not shown), or both (not shown). Additionally, or alternatively, the memory 612 may be distributed across multiple computing devices 600, for example, in a virtualized environment in which instruction processing is carried out on multiple computing devices 600. For the purposes of this disclosure, “computer storage media,” “computer-storage memory,” “memory,” and “memory devices” are synonymous terms for the computer-storage memory 612, and none of these terms include carrier waves or propagating signaling.

Processor(s) 614 may include any quantity of processing units that read data from various entities, such as memory 612 or I/O components 620. Specifically, processor(s) 614 are programmed to execute computer-executable instructions for implementing aspects of the disclosure. The instructions may be performed by the processor, by multiple processors within the computing device 600, or by a processor external to the client computing device 600. In some examples, the processor(s) 614 are programmed to execute instructions such as those illustrated in the flow charts discussed below and depicted in the accompanying drawings. Moreover, in some examples, the processor(s) 614 represent an implementation of analog techniques to perform the operations described herein. For example, the operations may be performed by an analog client computing device 600 and/or a digital client computing device 600. Presentation component(s) 616 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 600, across a wired connection, or in other ways. I/O ports 618 allow computing device 600 to be logically coupled to other devices including I/O components 620, some of which may be built in. Example I/O components 620 include, for example but without limitation, a microphone, joystick, game pad, satellite dish, scanner, printer, wireless device, etc.

Computing device 600 may operate in a networked environment via the network component 624 using logical connections to one or more remote computers. In some examples, the network component 624 includes a network interface card and/or computer-executable instructions (e.g., a driver) for operating the network interface card. Communication between the computing device 600 and other devices may occur using any protocol or mechanism over any wired or wireless connection. In some examples, network component 624 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 624 communicates over wireless communication link 626 and/or a wired communication link 626a to a remote resource 628 (e.g., a cloud resource) across network 630. Various different examples of communication links 626 and 626a include a wireless connection, a wired connection, and/or a dedicated link, and in some examples, at least a portion is routed through the internet.

Although described in connection with an example computing device 600, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure do not include signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A device management system comprising:
a processor; and
a computer-readable medium storing instructions that are operative upon execution by the processor to:
receive, from a first computing device, a boot image generation request and first image integrity data, the first image integrity data representing a first boot image;
store an image timestamp associated with the boot image generation request;
receive, from a second computing device, a message that includes second image integrity data, the second image integrity data representing a second boot image;
verify that the first image integrity data matches the second image integrity data;
determine that the message was received within a length of time from the image timestamp; and
register the second computing device with the device management system based on the verification and the determination.

2. The device management system of claim 1, wherein the instructions are further operative to:
transmit first enrollment metadata to the first computing device in response to the boot image generation request, the first enrollment metadata including one or more of user data, device data, and tenant data, the first enrollment metadata being included in the first boot image;
receive second enrollment metadata from the second computing device; and
verify that the first enrollment metadata matches the second enrollment data.

3. The device management system of claim 1, wherein the first image integrity data includes a first hash value generated by a hash algorithm using at least operating system data included in the first boot image, wherein the second image integrity data includes a second hash value generated by the hash algorithm using at least operating system data included in the second boot image.

4. The device management system of claim 1, wherein the instructions are further operative to:
identify a policy profile for the boot image generation request based on device data provided in the boot image generation request that identifies the second computing device, the policy profile defines at least an operating system version;
identify an operating system image associated with the operating system version; and
cause the operating system image to be sent to the first computing device and included in the first boot image.

5. The device management system of claim 1, wherein storing the image timestamp further comprises generating the image timestamp in response to receipt of the first image integrity data from the first computing device.

6. The device management system of claim 1, wherein the length of time is a preconfigured length of time identified based on one or more of an identity of an end user associated with the second computing device and a unique identifier associated with the second computing device.

7. The device management system of claim 1, further comprising the second computing device, wherein the second computing device is configured to:
perform a local integrity check of the second boot image during a boot process from an external disk device that stores at least the second boot image, the local integrity check comprises:
reading the first image integrity data from the external disk device;
computing the second image integrity data using at least operating system data retrieved from the external disk device;
comparing the first image integrity data to the second image integrity data; and
performing an operating system installation on the second computing device when the first image integrity data matches the second image integrity data.

8. A computer-implemented method comprising:
receiving, from a first computing device, a boot image generation request and first image integrity data, the first image integrity data representing a first boot image;
storing an image timestamp associated with the boot image generation request;
receiving, from a second computing device, a message that includes second image integrity data, the second image integrity data representing a second boot image;
verifying that the first image integrity data matches the second image integrity data;
determining that the message was received within a length of time from the image timestamp; and
registering the second computing device with the device management system based on the verification and the determination.

9. The method of claim 8, further comprising:
transmitting first enrollment metadata to the first computing device in response to the boot image generation request, the first enrollment metadata including one or more of user data, device data, and tenant data, the first enrollment metadata being included in the first boot image;
receiving second enrollment metadata from the second computing device; and
verifying that the first enrollment metadata matches the second enrollment data.

10. The method of claim 8, wherein the first image integrity data includes a first hash value generated by a hash algorithm using at least operating system data included in the first boot image, wherein the second image integrity data includes a second hash value generated by the hash algorithm using at least operating system data included in the second boot image.

11. The method of claim 8, further comprising:
identifying a policy profile for the boot image generation request based on device data provided in the boot image generation request that identifies the second computing device, the policy profile defines at least an operating system version;
identifying operating system data associated with the operating system version; and
transmitting the operating system data to the first computing device, the operating system data being included as at least a portion of the first boot image.

12. The method of claim 8, wherein storing the image timestamp further comprises generating the image timestamp in response to receipt of the first image integrity data from the first computing device.

13. The method of claim 8, wherein the length of time is a preconfigured length of time identified based on one or more of an identity of an end user associated with the second computing device and a unique identifier associated with the second computing device.

14. The method of claim 8, further comprising:
perform a local integrity check of the second boot image during a boot process of the second computing device and from an external disk device that is mounted to the second computing device and that stores at least the second boot image, the local integrity check comprising:
reading the first image integrity data from the external disk device;
computing the second image integrity data using at least operating system data retrieved from the external disk device;
comparing the first image integrity data to the second image integrity data; and
performing an operating system installation on the second computing device when the first image integrity data matches the second image integrity data.

15. A computer storage device having computer-executable instructions stored thereon, which, on execution by a computer, cause the computer to perform operations comprising:
receiving, from a first computing device, a boot image generation request and first image integrity data, the first image integrity data representing a first boot image;
storing an image timestamp associated with the boot image generation request;
receiving, from a second computing device, a message that includes second image integrity data, the second image integrity data representing a second boot image;
verifying that the first image integrity data matches the second image integrity data;
determining that the message was received within a length of time from the image timestamp; and
registering the second computing device with the device management system based on the verification and the determination.

16. The computer storage device of claim 15, further comprising:
transmitting first enrollment metadata to the first computing device in response to the boot image generation request, the first enrollment metadata including one or more of user data, device data, and tenant data, the first enrollment metadata being included in the first boot image;
receiving second enrollment metadata from the second computing device; and
verifying that the second enrollment metadata matches the first enrollment data.

17. The computer storage device of claim 15, wherein the first image integrity data includes a first hash value generated by a hash algorithm using at least operating system data included in the first boot image, wherein the second image integrity data includes a second hash value generated by the hash algorithm using at least operating system data included in the second boot image.

18. The computer storage device of claim 15, further comprising:
identifying a policy profile for the boot image generation request based on device data provided in the boot image generation request that identifies the second computing device, the policy profile defines at least an operating system version;
identifying operating system data associated with the operating system version; and
transmitting the operating system data to the first computing device, the operating system data being included as at least a portion of the first boot image.

19. The computer storage device of claim 15, wherein storing the first image timestamp further comprises generating the first image timestamp in response to receipt of the first image integrity data from the first computing device.

20. The computer storage device of claim 15, further comprising:
perform a local integrity check of the second boot image during a boot process of the second computing device and from an external disk device that is mounted to the second computing device and that stores at least the second boot image, the local integrity check comprising:
reading the first image integrity data from the external disk device;
computing the second image integrity data using at least operating system data retrieved from the external disk device;
comparing the first image integrity data to the second image integrity data; and
performing an operating system installation on the second computing device when the first image integrity data matches the second image integrity data.
